(19) United States
(12) Patent Application Publication
(10) Pub. No.: US 2005/0103105 A1
(43) Pub. Date: May 19, 2005

(54) Acceleration sensor system

(76) Inventors: Harald Emmerich, Reutlingen (DE); Hansjoerg Beutel, Reutlingen (DE)

Correspondence Address: KENYON & KENYON, ONE BROADWAY, NEW YORK, NY, 10004, US

(21) Appl. No.: 10/964,291

(22) Filed: Oct. 13, 2004

(30) Foreign Application Priority Data
Oct. 13, 2003 (DE) 10347418.8

(51) Int. Cl. G01P 15/125

(52) U.S. Cl. 73/493

(57) ABSTRACT

An acceleration sensor system is especially suitable for measuring low accelerations. The acceleration sensor system has at least: one premold housing made of a plastic material having a housing inner chamber, one lead frame which extends through the premold housing in the housing inner chamber, and one acceleration sensor chip, which is fastened in the housing inner chamber with the aid of an adhesive layer, and is connected to the lead frame with the aid of line bond connections. Advantageous stress decouplings are achieved in this connection by using an adhesive layer having a uniform thickness greater than 50 μm, preferably greater than 100 μm, in particular, the adhesive material of the adhesive layer being softer than the chip material of the acceleration sensor chip.

### FIELD OF THE INVENTION

The present invention relates to an acceleration sensor system, which is able to be used especially for measuring accelerations having tight tolerances of the sensor parameters with respect to temperature and service life.

### BACKGROUND INFORMATION

Acceleration sensor systems for low accelerations (low G acceleration sensors), which are used, for example, for measuring a braking deceleration or a slope inclination of a motor vehicle, are generally constructed in hybrid technology using hermetically sealed housings, in order to minimize environmental and temperature influences. However, such modules are generally not easy to combine using joining techniques suitable for mass production, such as printed circuit board assembly and press-in methods.

Such sensor systems have great sensitivity with regard to mechanical strains, since the sensor signals are generally read out capacitatively, and evaluated at high amplification. In cost-effective, printed circuit board-assembling assembly techniques, such as PLCC or SOIC, the sensor or the evaluation electronics is injection-molded around with plastic or molded. In sensors produced by microstructuring and integrated electronic circuits, because of different coefficients of expansion of the plastic and the semiconductor material of the sensors and the circuits, as well as on account of relaxation phenomena in the plastic, this leads to disadvantageous effects in the offset stability of the output voltage and the sensitivity. Furthermore, temperature variations, a nonlinear variation with respect to temperature, hystereses and long-term drift (particularly of the temperature variation) make their appearance. Moreover, the manufacturing tolerances of various samples, i.e. the different form of the effects, is considerable. That is why these cost-effectively employable construction techniques are hardly ever used in the case of acceleration sensors, especially low G acceleration sensors if there are safety-related requirements, e.g. in the motor vehicle field.

### SUMMARY OF THE INVENTION

By comparison, the acceleration sensor system according to the present invention particularly has the advantage that a sensor system having good measuring properties is achievable, using low production expenditure and advantageously low costs. In this connection, especially good electrical characteristic data, which correspond to those of known ceramic-hybrid constructions may be achieved, together with a good assembling capability on printed circuit boards in standard assembly processes (SMD). Consequently, for example, the sensors in control units and separately built sensors may be combined on one printed circuit board.

The sensor system according to the present invention is also adaptable to the respective requirements for the electrical sensor characteristic quantities and environmental influences. In this connection, as a function of the requirements, a requisite electrical performance and robustness with respect to environmental influences may be achieved in that, based on the flexible construction within the premold housing, components may be added in order to respond to higher requirements or components may be omitted appropriately for cost reduction.

A surprisingly good stress decoupling is achieved by using an adhesive layer having a uniform thickness greater than 50 μm, preferably greater than 100 μm, a soft adhesive material being used which is, in particular, softer than the chip material of the acceleration sensor chip.

Furthermore, according to the present invention, the sensor element and the evaluation chip may be stress-decoupled, so that tight electrical tolerances with respect to offset and receptivity, especially also low temperature variations, small nonlinearities with respect to temperature, hystereses, long-term drifts and lower manufacturing tolerances of the electrical characteristic values may be achieved.

The assembling of printed circuit boards may be achieved using standard machines in control units or separately built sensors. According to the present invention, since the electrical wiring configuration takes shape first on the printed circuit board, various functions, such as dielectric strength, electromagnetic compatibility, sensing direction may be implemented by simple changes in the printed circuit board layout and possibly a different assembly program of the printed circuit board assembler, without one's having to resort, for this, to costly, inflexible and expensive hybrids and metal modules. Furthermore, a mechanical stress decoupling of the acceleration sensor chip and the evaluation chip may be achieved.

Advantageously, an acceleration sensor chip is used having service life-stable and temperature-stable sensor parameters, so that a system is created which is stable over a long period of time even at the high loads in the automotive field.

The influence of environmental influences may be reduced, alternatively, by individual passivating layers, for instance, made of gel, on the surfaces of the sensor chip, evaluation chip and of bonding connections, or by applying a large-surface passivating area which encompasses the sensor chip, the evaluation chip and the line bonds. Such passivating by a larger gel mass may be realized at relatively low production costs and great long term stability. In this connection, a gel may advantageously be used that is stable to temperature and service life.

According to the present invention, a sensor chip and an additional evaluation chip, such as an ASIC, or, alternatively an acceleration sensor chip having an integrated evaluation circuit may be situated in the housing.

The chip or chips may, on the one hand, be cost-effectively adhered directly in the housing. Alternatively, the chip or chips may be affixed in the housing by using an intermediate layer. As the intermediate layer, one may use a substrate made, for instance, of silicon, glass, ceramic or metal, possibly even several platelets, to which the chip or chips are adhered; moreover, instead of a substrate, a conductive or a non-conductive adhesive layer may be used. Using such an intermediate layer, one may achieve a combination of mechanical stresses, for example, by different thermal coefficients of expansion, and thus a great stability of the electrical characteristic values. In addition, the substrates of the evaluation circuit and of the sensor chip may be put at any electrical potential desired. This improves the EMV or the electromagnetic compatibility.

According to the present invention, the acceleration sensor chip and the evaluation chip developed, for example, as an ASIC may be applied over one another, so that a decoupling of mechanical stresses is possible.

### BRIEF DESCRIPTION OF THE DRAWINGS

FIG. 1 shows a cross section through an acceleration sensor system according to one specific embodiment of the present invention.

FIG. 2 shows a cross section through an acceleration sensor system according to a further specific embodiment having an additional substrate.

FIG. 3 shows a cross section through an acceleration sensor system according to a still further specific embodiment having an internal chamber filled with gel.

### DETAILED DESCRIPTION

A sensor system 1 has a premold housing 2, 3 having housing lower part 2 and cover 3, which are bonded to each other in a connecting region 4, for instance, by laser welding or by adhesion, and which surround a housing inner chamber 5.

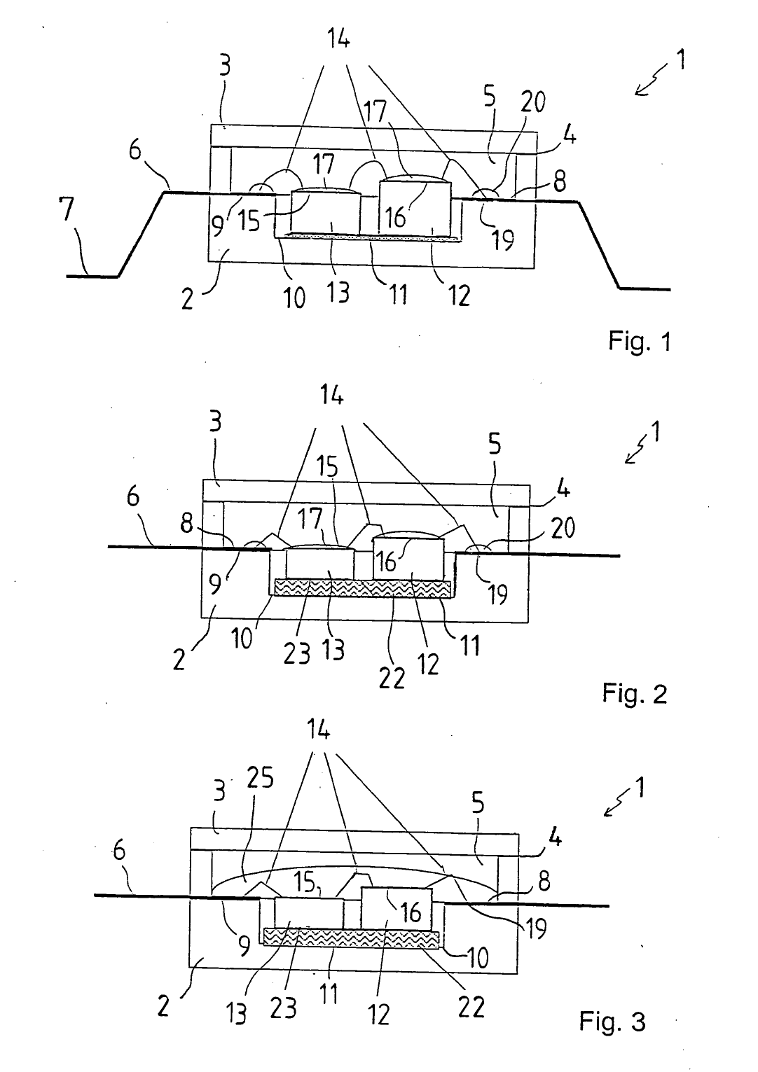

According to FIG. 1, a lead frame 6 runs through housing lower part 2 and may be set onto a printed circuit board (that is not shown) using its terminal pins 7. In the housing inner chamber 5, middle regions 8 of lead frame 6 run on a stage 9 of housing lower part 2. On a floor area 10 below stage 9, an adhesion layer 11 has been applied onto which a sensor chip 12 and an evaluation ship 13, e.g. an ASIC (application-specified integrated circuit) are applied. Adhesive layer 11 is advantageously formed by a soft adhesive, which in particular is softer than the material of sensor chip 12, and has a specified layer thickness. In this case, adhesive layer 11 may have a uniform thickness greater than 50 μm, advantageously greater than 100 μm, whereby a very good stress decoupling is achieved.

Chips 12, 13 are connected to each other and to lead frame 6 via line bonds 14. Chip surfaces 15, 16 of sensor chip 12 and evaluation chip 13 have been passivated using passivating layers 17 made of a gel. Furthermore, contact regions 19 of lead frame 6 are also provided together with line bonds 14 in housing inner chamber 5 with passivating layers 20 made of a gel.

In the specific embodiment of FIG. 2, as compared to the specific embodiment of FIG. 1, on floor surface 10 of housing lower part 2, with the aid of adhesive layer 11, a substrate 22, preferably a plane-parallel plate made, for instance, of silicon, a ceramic material or even a suitable metal is adhered, on whose upper side chips 12, 13 are adhered via an adhesive layer 23.

In the specific embodiment of FIG. 3, using an otherwise corresponding construction as in FIGS. 1 or 2, instead of passivating layers 17, 19 in housing inner chamber 5, a passivating layer 25 covering surfaces 15, 16 of chips 12, 13 as well as the middle region 8 of lead frame 6, and preferably also line bonds 14, is applied, a gel layer that preferably predominantly fills housing inner chamber 5.

Acceleration sensor chip 12 has elastic regions generated by microstructuring, e.g. vertical plates or reeds which are elastically deformed as a function of an acceleration or rotary speed acting on them, the measuring signal being read out capacitatively by evaluation chip 13.

1. An acceleration sensor system comprising:
at least one premold housing composed of a plastic material, having a housing inner chamber;
a lead frame extending through the premold housing into the housing inner chamber; and
an acceleration sensor chip fastened in the housing inner chamber with the aid of an adhesive layer and connected to the lead frame with the aid of line bond connections.

2. The acceleration sensor system according to claim 1, wherein the adhesive layer has a uniform thickness greater than 50 μm.

3. The acceleration sensor system according to claim 2, wherein the uniform thickness is greater than 100 μm.

4. The acceleration sensor system according to claim 1, wherein adhesive material of the adhesive layer is softer than chip material of the acceleration sensor chip.

5. The acceleration sensor system according to claim 1, further comprising an evaluation chip fastened in the housing inner chamber with the aid of the adhesive layer, and wherein the acceleration sensor chip is connected to the evaluation chip via the line bond connections.

6. The acceleration sensor system according to claim 1, further comprising an evaluation circuit monolithically integrated into the acceleration sensor chip.

7. The acceleration sensor system according to claim 5, further comprising, in the housing inner chamber, passivating layers applied at least one of (a) to a surface of at least one of the acceleration sensor chip and the evaluation chip and (b) onto connecting regions between the line bond connections and the lead frame.

8. The acceleration sensor system according to claim 5, wherein the housing inner chamber is filled at least partially with a passivating layer composed of gel, which covers at least one of (a) a surface of at least one of the acceleration sensor chip and the evaluation chip and (b) connecting regions between the line bond connections and the lead frame.

9. The acceleration sensor system according to claim 5, further comprising at least one substrate to which the acceleration sensor chip and the evaluation chip are adhered, the at least one substrate being fastened in the premold housing using the adhesive layer.

10. The acceleration sensor system according to claim 9, wherein the substrate is composed of one of silicon, a ceramic material and a metal.

11. The acceleration sensor system according to claim 9, wherein substrates of the sensor chip and of the evaluation circuit are adhered to different, electrically conductive substrates, and set to different electrical potentials.

12. The acceleration sensor system according to claim 5, wherein the acceleration sensor chip and the evaluation chip are situated one over the other.

13. The acceleration sensor system according to claim 1, wherein the premold housing has a housing lower part in which the acceleration sensor chip is fastened by the adhesive layer and has a cover connected to the housing lower part in a connecting region.
